(19) United States
(12) Patent Application Publication
(10) Pub. No.: US 2026/0175526 A1
(43) Pub. Date: Jun. 25, 2026

(54) THREE-DIMENSIONAL (3D) PRINTED ADAPTIVE BARRIER

(71) Applicant: INTERNATIONAL BUSINESS MACHINES CORPORATION, Armonk, NY (US)

(72) Inventors: NEIL DELIMA, Scarborough (CA); Carolina Garcia Delgado, Zapopan (MX); Sarbajit Kumar Rakshit, Kolkata (IN); Tushar Agrawal, West Fargo, ND (US)

(21) Appl. No.: 18/999,626

(22) Filed: Dec. 23, 2024

(51) Int. Cl. B29C 73/02; B29C 64/106; B29C 64/314; B29C 64/386; B33Y 10/00; B33Y 50/00

(52) U.S. Cl. CPC B29C 73/02; B29C 64/106; B29C 64/314; B29C 64/386; B33Y 10/00; B33Y 50/00

(57) ABSTRACT

A computer-implemented method for identifying a fluid at a leak site, analyzing characteristics of the fluid, and generating a simulation of the leak site comprising a digital twin of an environment comprising the leak site and the fluid based on the characteristics of the fluid. The method may further determine a chemical composition profile of a dynamic gel to act as a barrier at the leak site based on the simulation of the leak site and generate, using a mixing chamber, the dynamic gel to act as the barrier at the leak site by mixing components of the determined chemical composition profile.

### BACKGROUND

Aspects of the present invention relate generally to identifying an unwanted flow of fluid and preparing a customized adaptive barrier to control or stop the flow of fluid.

Magnetic slime is a type of slime or putty that contains tiny magnetic particles. It behaves like regular slime in terms of its texture but has the added feature of being attracted to magnets. When a magnet is brought near magnetic slime, the slime will move toward the magnet.

### SUMMARY

In a first aspect of the present invention, there is a computer-implemented method including: identifying, by a processor set, a fluid at a leak site; analyzing, by the processor set, characteristics of the fluid; generating, by the processor set, a simulation of the leak site comprising a digital twin of an environment comprising the leak site and the fluid based on the characteristics of the fluid; determining, by the processor set, a chemical composition profile of a dynamic gel to act as a barrier at the leak site based on the simulation of the leak site; and generating, by the processor set using a mixing chamber, the dynamic gel to act as the barrier at the leak site by mixing components of the determined chemical composition profile.

In another aspect of the present invention, there is a computer program product including one or more computer-readable storage media and program instructions stored on the one or more computer-readable storage media to perform operations. The operations include: identifying a fluid at a leak site; analyzing characteristics of the fluid; generating a simulation of the leak site comprising a digital twin of an environment comprising the leak site and the fluid; determining a chemical composition profile of a dynamic gel to act as a barrier at the leak site; and generating, using a mixing chamber, the dynamic gel to act as the barrier at the leak site by mixing components of the determined chemical composition profile.

In another aspect of the present invention, there is a system including a processor set, one or more computer readable storage media, and program instructions stored on the one or more computer-readable storage media to cause the processor set to perform operations. The operations include: identifying a fluid at a leak site; analyzing characteristics of the fluid; generating a simulation of the leak site comprising a digital twin of an environment comprising the leak site and the fluid; determining a chemical composition profile of a dynamic gel to act as a barrier at the leak site; and generating, using a mixing chamber, the dynamic gel to act as the barrier at the leak site by mixing components of the determined chemical composition profile.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

### DETAILED DESCRIPTION

Aspects of the present invention relate generally to identifying an unwanted flow of fluid and preparing a customized adaptive barrier to control or stop the flow of fluid.

According to an aspect of the present invention, the method, system, and computer program product include: determining an amount of counter force needed to apply on the flowing fluid; determining a required degree of profile change for the barrier created with sticky gel (e.g., a dynamic gel); determining a rate of profile changes for the sticky gel barrier dynamically customizing the sticky gel ink before printing; and controlling a ratio of ferromagnetic particles to sticky gel to maintain an appropriate viscosity and stickiness of the sticky gel ink.

In embodiments, the computer-implemented method, system, and computer program product further includes identifying appropriate ingredients and their required ratios based on simulations of activities to be performed with the 3D-printed object using sticky gel (e.g., sticky gel ink). In such embodiments, the 3D printing system may include a programmable mixing chamber for these ingredients to create sticky gel ink for 3D printing.

In embodiments, the computer-implemented method, system, and computer program product further includes, conducting a digital twin simulation to identify the 3D design of the barrier that needs to be printed with magnetic gel based on a comparison between properties of a customized magnetic gel ink, such as its ability to withstand force and its movability, and an amount of force required to resist the flowing fluid or stop leakage.

In embodiments, the computer-implemented method, system, and computer program product further includes, determining whether different sections of a 3D barrier require distinct properties of sticky gel ink, such as low versus high movability or deformability for the purpose of 3D printing of the barrier with sticky gel (e.g., sticky gel ink); segmenting the 3D design of the barrier; and customizing the sticky gel ink based on the particular section of the 3D barrier to be printed.

In embodiments, the computer-implemented method, system, and computer program product further includes, receiving a 3D model, recognizing properties for different sections of the barrier, and creating a quantity and specification of sticky gel ink for the 3D printing process in collaboration with mixing chamber.

In embodiments, the computer-implemented method, system, and computer program product further includes incorporating ferromagnetic particles or magnetic chips into the sticky gel so that with external magnetic force the sticky-gel barrier can exhibit a movement when a non-ferromagnetic gel ink cannot achieve the necessary rate of profile change when subjected to electromagnetic force.

Implementations of the present invention are necessarily rooted in computer technology. For example, generating a simulation of a leak site comprising a digital twin of an environment comprising the leak site and the fluid based on the characteristics of the fluid, determining a chemical composition profile of a dynamic gel (e.g., sticky gel) to act as a barrier at the leak site based on the simulation of the leak site, generating, using a mixing chamber, the dynamic gel to act as the barrier at the leak site by mixing components of the determined chemical composition profile, and printing, using a three-dimensional printer, a determined shape using the generated dynamic gel, are computer-based and cannot be performed in the human mind.

Conventional methods for identifying and repairing pipe leaks can be inadequate for hard-to-reach places and often require a significant amount of manpower. For example, leaks in confined, elevated, or underground spaces (such as deep pipelines, beneath concrete, or inside walls) are difficult to inspect visually and difficult to repair once detected. Inspectors may need to manually access these locations, which can require tearing down walls, digging up ground, or using scaffolding, adding time, effort, and cost. Furthermore, traditional repairs only provide a temporary fix, such as applying sealant patches or clamps to the leak. These methods may not be as reliable or long-lasting as more permanent repairs, and they require regular monitoring and maintenance to ensure the issue doesn't recur

Embodiments and aspects of the present invention provide systems and methods that improve and advance the technology in a specific and practical application. In other words, the methods, systems, and computer program products described herein improve the functioning of a improve the technology of identifying an unwanted flow of fluid and preparing a customized adaptive barrier to control or stop the flow of fluid by providing methods for by providing methods for: identifying a fluid at a leak site; analyzing characteristics of the fluid; generating a simulation of the leak site comprising a digital twin of an environment comprising the leak site and the fluid; determining a chemical composition profile of a dynamic gel to act as a barrier at the leak site; and generating a dynamic gel to act as the barrier at the leak site.

It should be understood that, to the extent implementations of the present invention collect, store, or employ personal information provided by, or obtained from, individuals (e.g., data captured while scanning for leaks), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks/operations may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, adaptive barrier generation code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

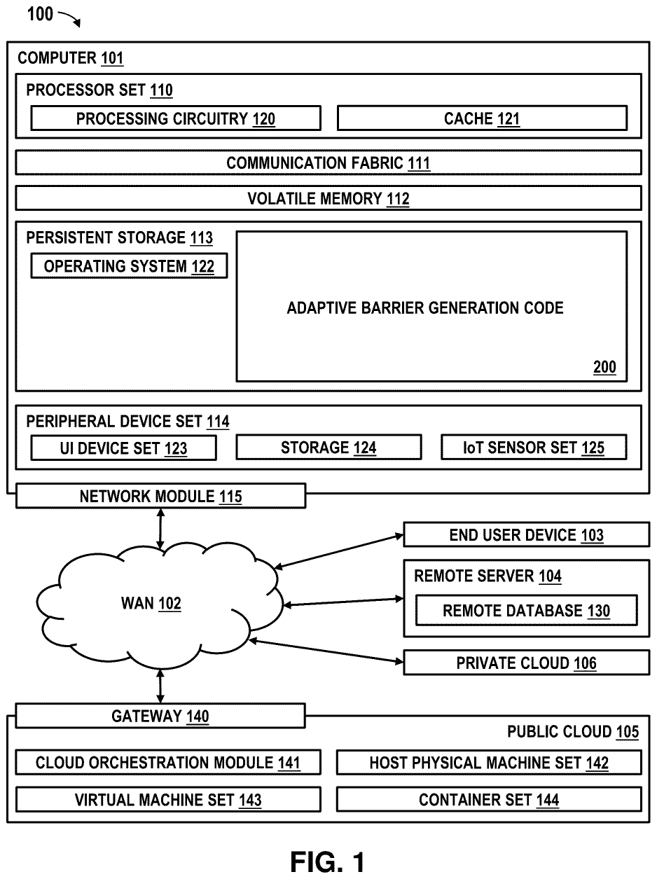

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

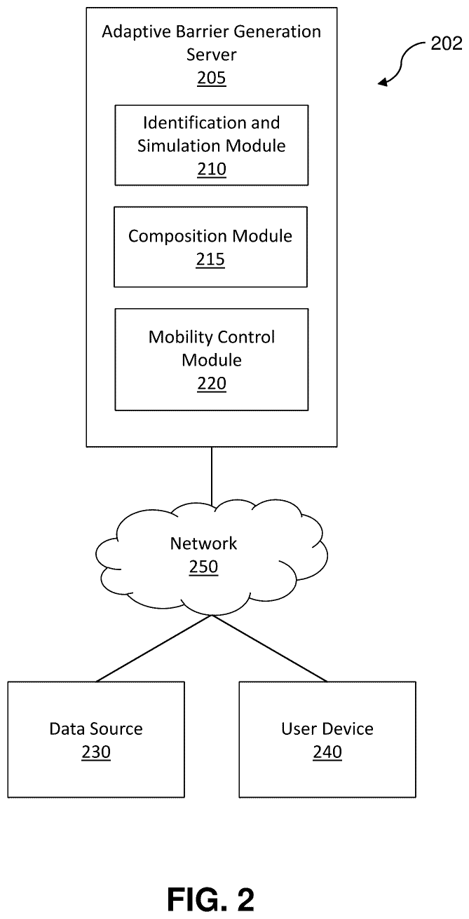

FIG. 2 shows a block diagram of exemplary environment 202 in accordance with aspects of the present invention. In embodiments, environment 202 includes adaptive barrier generation server 205, data sources 230, user device 240, and network 250.

Adaptive barrier generation server 205 may comprise one or more instances of computer 101 of FIG. 1. In another example, adaptive barrier generation server 205 may comprise one or more virtual machines or containers running on one or more instances of computer 101 of FIG. 1. In embodiments, adaptive barrier generation server 205 communicates with data sources 230 and user device 240 via network 250, which may comprise WAN 102 of FIG. 1. In embodiments, data sources 230 comprise one or more data sources each comprising an instance of remote database 130 and/or remote server 104 of FIG. 1. In embodiments, user device 240 comprises an instance of end user device 103 of FIG. 1. There may be plural different instances of user device 240 including, for example, personal computing devices, three-dimensional (3D) printing devices, mixing chambers, and/or any other device useful for generating an adaptive barrier as disclosed herein. The different instances of user device 240 may be used by different users, evaluators, operators, technicians, etc.

In embodiments, adaptive barrier generation server 205 of FIG. 2 comprises identification and simulation module 210, composition module 215, and mobility control module 220, each of which may comprise modules of the code of block 200 of FIG. 1. Such modules may include routines, programs, objects, components, logic, data structures, and so on that perform a particular task (or tasks) or implement a particular data type (or types) that the code of block 200 uses to carry out the functions and/or methodologies of embodiments of the present invention as described herein. These modules of the code of block 200 are executable by computer 101 of FIG. 1 (e.g., processing circuitry 120 of FIG. 1) to perform the inventive methods as described herein. Adaptive barrier generation server 205 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, adaptive barrier generation server 205 is configured to facilitate communication between identification and simulation module 210, composition module 215, mobility control module 220, and external storage (e.g., data source 230) and devices (e.g., user device 240) via network 250.

In accordance with aspects of the present invention, identification and simulation module 210 is configured to detect a leak and/or an unwanted flow of fluid. As used herein, fluid refers to a substance that flows and deforms continuously under applied force, having no fixed shape. In embodiments, the fluid may be a liquid, which has a definite volume but takes the shape of their container, and/or a gas, which expands to fill any container and has neither a fixed volume nor shape. In embodiments, a fluid may refer to a chemical composition that is liquid in certain environmental conditions and is a gas in other environmental conditions.

In embodiments, identification and simulation module 210 may be equipped with cameras and/or other visual sensors as part of a visual recognition system. For example, identification and simulation module 210 may use cameras to capture images or videos, and sensors such as infrared or depth sensors to detect objects, movement, physical conditions (e.g., wet spots, rust, stains, corrosion), and/or environmental conditions, enabling it to detect a leak and/or an unwanted flow of fluid. In embodiments, identification and simulation module 210 may also, or alternatively, use internet-of-things (IoT) sensors. For example, IoT sensors may be deployed to monitor parameters such as temperature, pressure, humidity, or gas composition, allowing the system to detect abnormalities or potential issues in real-time, such as a fluid leak or changes in fluid flow that may require attention. In embodiments, identification and simulation module 210 may implement dye testing or fluorescent tracers to make leaks more visible under UV light. In embodiments, identification and simulation module 210 may use thermal imaging cameras to detect temperature differences caused by leaking fluids. In such embodiments, hot spots or cold spots may indicate the presence of leaks.

In yet additional embodiments, identification and simulation module 210 may further apply machine learning algorithms trained to analyze an image to detect a leak and/or an unwanted flow of fluid. For example, the machine learning algorithms may be trained on a dataset of labeled images to recognize patterns indicative of leaks or fluid flow anomalies, enabling the system to autonomously identify potential issues by analyzing visual data captured by the cameras or sensors. Machine learning algorithms may include convolutional neural networks (CNNs) for image recognition, support vector machines (SVMs) for classification tasks, decision trees for pattern identification, and recurrent neural networks (RNNs) for analyzing time-series data from sensors to detect fluid flow anomalies or leaks.

In embodiments, identification and simulation module 210 may further use in-system sensors to perform real-time monitoring that can detect abnormal flow rates or pressure within an industrial system. For example, in-system sensors may detect a sudden drop in pressure or an increase in flow rate that deviates from normal operating conditions, indicating a potential leak or blockage. These sensors can continuously monitor parameters such as temperature, pressure, and flow, allowing identification and simulation module 210 to quickly identify irregularities and initiate appropriate responses to address the issue in real-time.

In embodiments, identification and simulation module 210 may further use ultrasonic leak detectors to identify high-frequency sound waves emitted by leaking fluids or gases. For example, ultrasonic leak detectors may pick up the characteristic high-frequency sound waves produced by a pressurized fluid or gas escaping from a pipe or valve. These sound waves can be analyzed by identification and simulation module 210 to pinpoint the exact location of the leak, enabling more precise identification of the leak site (e.g., leak origin, leak source, etc.) and allowing for faster remediation actions.

Responsive to detecting a leak and/or an unwanted flow of fluid, identification and simulation module 210 may be further configured to determine the characteristics of the fluid. For example, in embodiments, identification and simulation module 210 may determine the chemical composition, viscosity, thickness, strength, temperature, pressure, flow speed, and/or any other characteristic that may be useful for preventing the fluid from spreading and/or mitigating an environmental impact. In embodiments, identification and simulation module 210 may follow a set of predefined rules to identify whether the fluid is to be covered with a barrier, or whether it should be redirected to an appropriate location.

In embodiments, identification and simulation module 210 may receive, access, and/or obtain information about the fluid from an entity (e.g., a company, manufacturer, person, etc.) responsible for the fluid. In embodiments where identification and simulation module 210 detects a fluid leaking from a pipe in a manufacturing or chemical transport system, the fluid, flow rate, and pressure may be known. In such instances, identification and simulation module 210 may obtain that information from a data source that contains the relevant information. For example, if it is known that a pipe is carrying oil or fuel, identification and simulation module 210 may obtain information such as the type of fluid, its viscosity, density, and chemical properties, as well as the expected flow rate and pressure, from a database or real-time monitoring system provided by the manufacturer or system operator.

In embodiments, responsive to detecting a leak and/or an unwanted flow of fluid, identification and simulation module 210 may be further configured to determine the characteristics of an origin of the leak. For example, identification and simulation module 210 may employ cameras, visual sensors, IoT sensors, etc., to find a cracked pipe, an open valve, a damaged seal, or a malfunctioning joint, all of which could be potential sources of the leak or unwanted fluid flow. In embodiments, machine learning algorithms, including convolutional neural networks (CNNs) for image recognition, support vector machines (SVMs) for classification tasks, decision trees for pattern identification, and recurrent neural networks (RNNs) for analyzing time-series data from sensors to detect sources of fluid flow anomalies or leaks. In embodiments, identification and simulation module 210 is configured to create a model of the identified leak site, including the size, shape, and/or other characteristics of the leak site. In such embodiments, the model may be a digital twin model of the leak site and/or the environment where the leak site is located.

In embodiments, identification and simulation module 210 may be further configured to perform a simulation for how a dynamic gel composition profile (e.g., as determined by composition module 215), may perform under the conditions. For example, identification and simulation module 210 may model gel behavior and its interaction with a fluid, pressure, temperature, and/or environmental factors at the leak site. This simulation can predict how well the simulated dynamic gel might form a barrier, its rate of viscosity change, and its ability to adhere to and seal the leak site (e.g., leak origin, leak source, etc.) under the specific conditions, helping composition module 215 to refine the gel composition profile (e.g., gel formulation) before actual deployment.

In accordance with aspects of the present invention, composition module 215 is configured to identify, discover, and/or determine a dynamic gel composition profile (e.g., a target profile) that describes properties of potential gels (e.g., dynamic gels) capable of forming a barrier to close, block, and/or seal the leak site. For example, composition module 215 may analyze the characteristics of the fluid, such as viscosity, temperature, and chemical composition, to determine the appropriate gel composition profile (e.g., gel formulation) that can effectively bond to the leak site (e.g., leak origin, leak source, etc.), withstand the environmental conditions, and form a durable seal to stop the fluid from escaping.

As used herein, composition refers to the specific formulation or mixture of materials, including the proportions and types of substances, that make up the gel. This may include, for example, ingredients such as polymers, cross-linking agents, stabilizers, and other additives that contribute to gel (e.g., dynamic gel) properties, such as its ability to form a barrier, adhere to surfaces, and resist degradation under the conditions present at the leak site. In embodiments, the composition may further include magnetic materials, such as iron oxide or ferrite particles, to enable the gel to be attracted to or manipulated by magnetic fields, facilitating precise placement or reinforcement at the leak site for enhanced sealing effectiveness.

In embodiments, composition module 215 may analyze historical data to determine how historical gel composition profiles have performed in the same, or similar, conditions. For example, if a magnetic gel having a specific composition has historically quenched similar leaks (e.g., similar fluid, temperature, pressure, etc.), composition module 215 may consider that data in identifying, discovering, and/or determining a gel composition profile for a present and/or current leak.

In embodiments, the gel composition profile may be sent to identification and simulation module 210 to be tested and simulated on a 3D model of a leak site. In such embodiments, additional feedback may be received from identification and simulation module 210 indicating that the gel composition profile passed a simulated barrier integrity test, that the gel profile failed the simulated barrier integrity test, and/or additional feedback indicating features and/or characteristics that need improvement. The barrier integrity test refers to a simulated assessment or evaluation designed to determine whether a gel composition can effectively seal or control a leak under specific conditions.

In embodiments, composition module 215 may be configured to generate a gel composition data file that contains the specific gel composition to effectively seal or control a detected leak. In embodiments, the data file may be sent to a mixing chamber (e.g., which may include at least one instance of user device 240). In additional embodiments, composition module 215 may send the gel composition data to the mixing chamber without generating a gel composition data file. In such embodiments, the data may be sent directly in a digital format or as a set of instructions to the mixing chamber, bypassing the need for a separate data file. This direct transmission could involve sending the specific parameters or components of the gel composition, such as the ratios of ingredients, additives, or other formulation details, to the mixing chamber for real-time processing and preparation of the gel. The mixing chamber would then use the gel composition data file or the directly transmitted data to prepare the gel composition.

In embodiments, the mixing chamber may be local to adaptive barrier generation server 205. In other embodiments, the mixing chamber may be remote from adaptive barrier generation server 205.

In accordance with aspects of the present invention, mobility control module 220 is configured to print the prepared gel composition to a predetermined shape using a 3D printer. In embodiments, mobility control module 220 may be configured to generate a 3D print data file that contains the specific shape and/or instructions for printing the gel composition to effectively seal or control a detected leak. As used herein, controlling a detected leak refers to controlling the flow rate of the leak without completely sealing the leak site. In embodiments, the data file may be sent to a 3D printer (e.g., which may include at least one instance of user device 240). In additional embodiments, composition module 215 may send the specific shape and/or instructions for printing the gel composition to the 3D printer without generating a 3D print data file. In such embodiments, the data may be sent directly in a digital format or as a set of instructions to the 3D printer, bypassing the need for a separate data file. This direct transmission could involve sending the specific shape, thickness, strength, design parameters, or printing instructions directly to the 3D printer in a digital format, such as a set of commands or a data stream. These instructions would detail the exact geometry, layer-by-layer deposition, and material properties required for printing the gel composition. The 3D printer would then use this real-time data to fabricate the gel structure, without the need for an intermediary data file, enabling a more streamlined and efficient process for creating the gel barrier for leak control.

In embodiments, the 3D printer may be local to adaptive barrier generation server 205. In other embodiments, the 3D printer may be remote from adaptive barrier generation server 205. In other embodiments, the mixing chamber may be remote from adaptive barrier generation server 205.

In embodiments where the leak site is located in an area that is not reachable by the 3D printer, the 3D print data file and/or the direct data transmission sent by mobility control module 220 may further include instructions for printing the gel composition in one location and instructions for controlling the flow of a magnetic gel into a location to block the leak. In other words, mobility control module 220 may generate a 3D print data file and/or the direct data transmission that provides both the design and location-specific instructions for printing the gel (e.g., dynamic gel) composition at a reachable area, while simultaneously including guidance for directing the flow of the magnetic gel to the actual leak site. This could involve coordinating the printing process with a mechanism that controls the movement or delivery of the gel, such as using magnetic fields or other means, to ensure the gel reaches the leak location and effectively blocks or seals the leak.

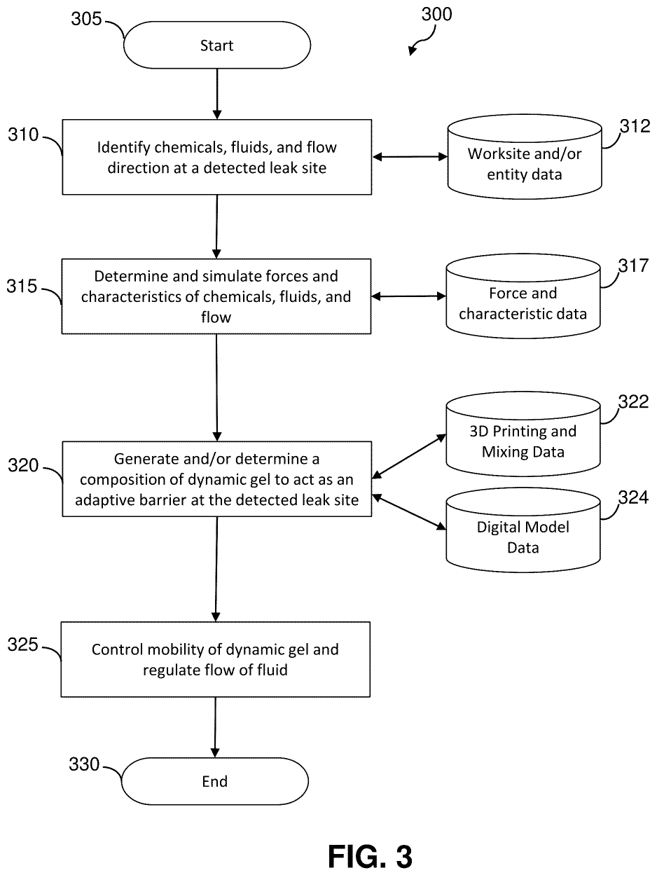

FIG. 3 shows a flowchart of exemplary method 300 in accordance with aspects of the present invention. Operations of the method may be carried out in the environment of FIG. 2 and are described with reference to elements depicted in FIG. 2.

At operation 305 of FIG. 3, adaptive barrier generation server 205 is configured to begin method 300, to three-dimensional (3D) print an adaptive barrier. At operation 310, identification and simulation module 210 of FIG. 2 is configured to identify chemicals, fluids, and flow direction at a detected leak site. In other words, identification and simulation module 210 is configured to detect a leak and/or an unwanted flow of fluid and determine the characteristics of the fluid.

In embodiments, identification and simulation module 210 may receive, access, and/or obtain data about the fluid from a worksite and/or entity 312 (e.g., one or more instances of data source 230 of FIG. 2) responsible for the fluid. In embodiments, identification and simulation module 210 may also store information at the worksite and/or entity based on the identified fluid characteristics of the detected leak site. By storing this data, it may help identify those characteristics more easily in the future and may be used to train the identification algorithms.

At operation 315, identification and simulation module 210 of FIG. 2 is configured to determine and simulate forces and characteristics of the chemicals, fluids, and flow. For example, in embodiments, identification and simulation module 210 may determine the chemical composition, viscosity, temperature, pressure, flow speed, and/or any other characteristic that may be useful for preventing the fluid from spreading and/or mitigating an environmental impact. Identification and simulation module 210 may also determine the characteristics of leaks origin. For example, identification and simulation module 210 may employ cameras, visual sensors, IoT sensors, etc., to find a cracked pipe, an open valve, a damaged seal, or a malfunctioning joint, all of which could be potential sources of the leak or unwanted fluid flow.

In embodiments, determining the forces and characteristics of the chemicals, fluids, and flow may be aided by force and characteristic data 317 (e.g., one or more instances of data source 230 of FIG. 2). In such embodiments, identification and simulation module 210 may receive, access, and/or obtain data about the force and characteristic (i.e., chemical composition) at the worksite and/or from the entity. In embodiments, identification and simulation module 210 may create a mesh that discretizes the geometry of into smaller elements (e.g., cells or elements). The mesh quality can significantly impact simulation accuracy.

In embodiments, identification and simulation module 210 may be further configured to perform a simulation for how a dynamic gel composition profile (e.g., as determined by composition module 215), may perform under the conditions. For example, identification and simulation module 210 may model dynamic gel behavior and its interaction with a fluid, pressure, temperature, and/or environmental factors at the leak site. In embodiments, the simulation data is stored with and/or as force and characteristic data 317.

At operation 320, composition module 215 of FIG. 2 is configured to generate and/or determine a composition of dynamic gel to act as an adaptive barrier at the detected leak site. In other words, composition module 215 may be configured to identify, discover, and/or determine a gel composition profile (e.g., a target profile) that describes properties of potential gels capable of forming a barrier to close, block, and/or seal the leak site. For example, composition module 215 may analyze the characteristics of the fluid, such as viscosity, temperature, and chemical composition, to determine the appropriate gel composition profile (e.g., gel formulation) that can effectively bond to the leak site, withstand the environmental conditions, and form a durable seal to stop the fluid from escaping.

In embodiments, composition module 215 may generate and/or determine the composition based on the simulation performed at operation 315. In embodiments, composition module 215 may also generate and/or determine the composition based on historical 3D printing and mixing data 322 (e.g., one or more instances of data source 230 of FIG. 2) to determine how historical gel composition profiles have performed in the same, or similar, conditions. For example, if a magnetic gel having a specific composition has historically quenched similar leaks (e.g., similar fluid, temperature, pressure, etc.), composition module 215 may consider that data in identifying, discovering, and/or determining a gel composition profile for a present and/or current leak. In embodiments, composition module 215 may also generate and/or determine the composition based on digital model data 324 (e.g., one or more instances of data source 230 of FIG. 2) such as the simulations of operation 315 and/or digital models created related to the leak site, the shape of the leak site, or any other feature that might affect the success and/or failure of an adaptive barrier.

At operation 325, mobility control module 220 of FIG. 2 is configured to control mobility of dynamic gel and regulate flow of fluid. In other words, mobility control module 220 is configured to print the gel composition to a predetermined shape using a 3D printer. In embodiments, the flow may be regulated and not blocked. In other words, the mobility control module 220 is designed to not only control the movement and flow of the dynamic gel but also to print the gel into a specific shape using 3D printing technology. This allows for precise placement of the gel in response to detected leaks, with the ability to regulate the flow rather than completely block it. At operation 330, adaptive barrier generation server 205 is configured to terminate method 300.

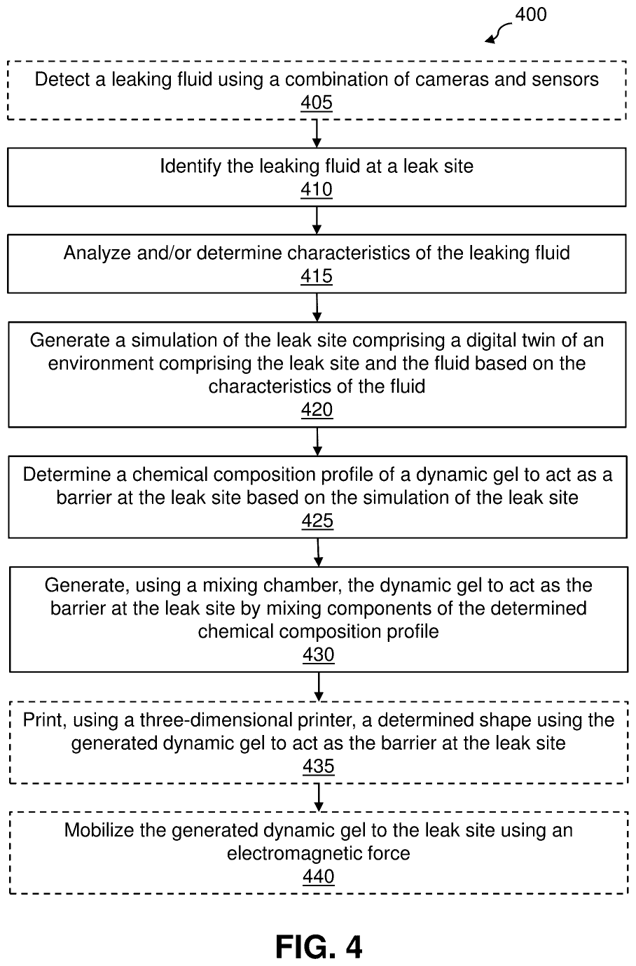

FIG. 4 shows a flow diagram of an exemplary method 400 in accordance with aspects of the present invention. Operations of the method 400 are described with reference to elements and actions depicted in and described with reference to FIGS. 2 and 3.

At operation 405, the system (e.g., an instance of adaptive barrier generation server 205 of FIG. 2 and/or any of adaptive barrier generation server 205's modules) may be optionally configured (as indicated by the dotted lines) to detect a leaking fluid using a combination of cameras and sensors. In embodiments, operation 405 may be performed in accordance with operation 310 of FIG. 3 and/or as described with respect to identification and simulation module 210 of FIG. 2. For example, identification and simulation module 210 may use cameras to capture images or videos, and sensors such as infrared or depth sensors to detect objects, movement, physical conditions (e.g., wet spots, rust, stains, corrosion), and/or environmental conditions, enabling it to detect a leak and/or an unwanted flow of fluid.

At operation 410, the system (e.g., an instance of identification and simulation module 210 of FIG. 2) may be configured to identify the leaking fluid at a leak site. In embodiments, identifying the leaking fluid may be performed in accordance with operation 310 of FIG. 3 and/or as described with respect to identification and simulation module 210 of FIG. 2. For example, identification and simulation module 210 may apply machine learning algorithms trained to analyze an image to detect a leak and/or an unwanted flow of fluid.

At operation 415, the system (e.g., an instance of identification and simulation module 210 of FIG. 2) may be configured to analyze and/or determine characteristics of the leaking fluid. In embodiments, analyzing and/or determining the characteristics of the fluid may be performed in accordance with operation 315 of FIG. 3 and/or as described with respect to identification and simulation module 210 of FIG. 2. For example, in embodiments, identification and simulation module 210 may determine the chemical composition, viscosity, temperature, pressure, flow speed, and/or any other characteristic that may be useful for preventing the fluid from spreading and/or mitigating an environmental impact.

At operation 420, the system (e.g., an instance of identification and simulation module 210 of FIG. 2) may be configured to generate a simulation of the leak site comprising a digital twin of an environment comprising the leak site and the fluid based on the characteristics of the fluid. In embodiments, generating the simulation of the leak site may be performed in accordance with operation 315 of FIG. 3 and/or as described with respect to identification and simulation module 210 of FIG. 2. For example, identification and simulation module 210 may be configured to perform a simulation for how a gel composition profile (e.g., as determined by composition module 215), may perform under the conditions.

At operation 425 the system (e.g., an instance of composition module 215 of FIG. 2) may be configured to determine a chemical composition profile of a dynamic gel to act as a barrier at the leak site based on the simulation of the leak site. In embodiments, determining the chemical composition profile of the dynamic gel may be performed in accordance with operation 320 of FIG. 3 and/or as described with respect to composition module 215 of FIG. 2. For example, chemical compositions may include ingredients such as polymers, cross-linking agents, stabilizers, and other additives that contribute to the gel's properties, such as its ability to form a barrier, adhere to surfaces, and resist degradation under the conditions present at the leak site. In embodiments, the composition may further include magnetic materials, such as iron oxide or ferrite particles, to enable the gel to be attracted to or manipulated by magnetic fields, facilitating precise placement or reinforcement at the leak site for enhanced sealing effectiveness.

At operation 430, the system (e.g., an instance of composition module 215 of FIG. 2) may be configured to generate, using a mixing chamber, the dynamic gel to act as the barrier at the leak site by mixing components of the determined chemical composition profile. In embodiments, determining the chemical composition profile of the dynamic gel may be performed in accordance with operation 320 of FIG. 3 and/or as described with respect to composition module 215 of FIG. 2. For example, composition module 215 may be configured to generate a gel composition data file that contains the specific gel composition to effectively seal or control a detected leak.

At operation 435, the system (e.g., an instance of mobility control module 220 of FIG. 2) may optionally be configured to print, using a three-dimensional printer, a determined shape using the generated dynamic gel to act as the barrier at the leak site. In embodiments, printing the shape using the dynamic gel may be performed in accordance with operations 320 and 325 of FIG. 3 and/or as described with respect to mobility control module 220 of FIG. 2. For example, in embodiments, mobility control module 220 may be configured to generate a 3D print data file that contains the specific shape and/or instructions for printing the gel composition to effectively seal or control a detected leak.

At operation 440, the system (e.g., an instance of mobility control module 220 of FIG. 2) may optionally be configured to mobilize the generated dynamic gel to the leak site using an electromagnetic force. In embodiments, mobilizing the dynamic gel may be performed in accordance with operation 325 of FIG. 3 and/or as described with respect to mobility control module 220 of FIG. 2. For example, in embodiments where the leak site is located in an area that is not reachable by the 3D printer, the 3D print data file and/or the direct data transmission sent by mobility control module 220 may further include instructions for printing the gel composition in one location and instructions for controlling the flow of a magnetic gel into a location to block the leak. In embodiments, the 3D printer may include a robotic arm capable of reaching, and printing, in areas unreachable by conventional 3D printers.

In embodiments, a service provider could offer to perform the processes described herein. In this case, the service provider can create, maintain, deploy, support, etc., the computer infrastructure that performs the process steps of aspects of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, aspects of the present invention provide a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system may include one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying, by a processor set, a fluid at a leak site;
analyzing, by the processor set, characteristics of the fluid;
generating, by the processor set, a simulation of the leak site comprising a digital twin of an environment comprising the leak site and the fluid based on the characteristics of the fluid;
determining, by the processor set, a chemical composition profile of a dynamic gel to act as a barrier at the leak site based on the simulation of the leak site; and
generating, by the processor set and using a mixing chamber, the dynamic gel to act as the barrier at the leak site by mixing components of the determined chemical composition profile.

2. The computer-implemented method of claim 1, further comprising printing, by the processor set using a three-dimensional printer, a determined shape using the generated dynamic gel to act as the barrier at the leak site.

3. The computer-implemented method of claim 2, further comprising mobilizing the generated dynamic gel to the leak site using an electromagnetic force.

4. The computer-implemented method of claim 1, further comprising detecting a leaking fluid using a combination of cameras and sensors.

5. The computer-implemented method of claim 1, wherein the characteristics of the fluid comprise a chemical composition, flow rate, and pressure of the fluid.

6. The computer-implemented method of claim 1, wherein the chemical composition profile of the dynamic gel comprises magnetic materials.

7. The computer-implemented method of claim 6, wherein the dynamic gel is configured to act as the barrier at the leak site to block the fluid from leaking.

8. The computer-implemented method of claim 6, wherein the dynamic gel is configured to act as the barrier at the leak site to control a flow rate of the fluid.

9. A computer program product comprising:
one or more computer-readable storage media; and
program instructions stored on the one or more computer-readable storage media to perform operations comprising:
identifying a fluid at a leak site;
analyzing characteristics of the fluid;
generating a simulation of the leak site comprising a digital twin of an environment comprising the leak site and the fluid;
determining a chemical composition profile of a dynamic gel to act as a barrier at the leak site; and
generating, using a mixing chamber, the dynamic gel to act as the barrier at the leak site by mixing components of the determined chemical composition profile.

10. The computer program product of claim 9, wherein the operations further comprise:
printing, by the processor set using a three-dimensional printer, a determined shape using the generated dynamic gel to act as the barrier at the leak site; and
mobilizing the generated dynamic gel to the leak site using an electromagnetic force.

11. The computer program product of claim 10, wherein the operations further comprise detecting a leaking fluid using a combination of cameras and sensors.

12. The computer program product of claim 9, wherein the characteristics of the fluid comprise a chemical composition, flow rate, and pressure of the fluid.

13. The computer program product of claim 9, wherein the chemical composition profile of the dynamic gel comprises magnetic materials.

14. The computer program product of claim 9, wherein the dynamic gel is configured to act as the barrier at the leak site to block the fluid from leaking.

15. A computer system comprising:
a processor set;
one or more computer-readable storage media; and
program instructions stored on the one or more computer-readable storage media to cause the processor set to perform operations comprising:
identifying a fluid at a leak site;
analyzing characteristics of the fluid;
generating a simulation of the leak site comprising a digital twin of an environment comprising the leak site and the fluid;
determining a chemical composition profile of a dynamic gel to act as a barrier at the leak site; and
generating, using a mixing chamber, the dynamic gel to act as the barrier at the leak site by mixing components of the determined chemical composition profile.

16. The computer system of claim 15, wherein the operations further comprise printing, by the processor set using a three-dimensional printer, a determined shape using the generated dynamic gel to act as the barrier at the leak site.

17. The computer system of claim 16, wherein the operations further comprise mobilizing the generated dynamic gel to the leak site using an electromagnetic force.

18. The computer system of claim 15, wherein the operations further comprise detecting a leaking fluid using a combination of cameras and sensors.

19. The computer system of claim 15, wherein the chemical composition profile of the dynamic gel comprises magnetic materials.

20. The computer system of claim 15, wherein the dynamic gel is configured to act as the barrier at the leak site to control a flow rate of the fluid.
